(19) United States
(12) Patent Application Publication
(10) Pub. No.: US 2011/0067693 A1
(43) Pub. Date: Mar. 24, 2011

(54) INTEGRATED MOUNT FOR SOLAR PANELS

(75) Inventor: James B. PAULL, Andover, MA (US)

(73) Assignee: STELLARIS CORPORATION, North Billerica, MA (US)

(21) Appl. No.: 12/887,808

(22) Filed: Sep. 22, 2010

Related U.S. Application Data
(60) Provisional application No. 61/244,763, filed on Sep. 22, 2009.

(51) Int. Cl. F24J 2/46; B23P 11/00

(52) U.S. Cl. 126/704; 29/428

(57) ABSTRACT

Apparatus and methods are disclosed for reducing or eliminating the need for an intermediate supporting rack in a solar panel installation, which in turn may lower the cost of the installation. In one exemplary embodiment, a mount design is provided that includes a mounting flange attached to or integrally formed with a first side of a solar panel frame. This first side and flange operate together with a second side of the solar panel frame that is designed to engage with the mounting flange and first side of an adjacent solar panel. The geometry of the first and second sides may be such that they engage upon installation. The engagement may further include pins or similar components protruding from one side of one solar panel to fit into corresponding holes in a side of an adjacent panel.

### CROSS-REFERENCE TO RELATED APPLICATIONS

This application claims the benefit of U.S. Provisional Application No. 61/244,763, filed Sep. 22, 2009, the teachings of which are incorporated by reference.

### FIELD

This disclosure relates to solar devices, such as those that produce electricity from the sun or harvest thermal energy from the sun, and, more particularly, to integrated mounting systems for such devices.

### BACKGROUND

Solar panels may be typically mounted on an intermediate supporting structure. For example, the intermediate supporting structure may be a rack on the roof of a house or commercial building or a structure designed specifically to support solar panels on the ground. Such racks and similar intermediate supporting structures may often be made from extruded aluminum shapes that may then be joined together with hardware such as clips and bolts.

These racks and structures may often be designed to be attached to a roof in a limited number of discrete locations, such as at roof rafters, in order to transfer mechanical loads from the solar panels to structural elements of a building. These attachment points may then be sealed to be watertight using flashing, roofing sealants and other means commonly known in the industry.

The materials and labor required for these intermediate supporting structures, as well as the subsequent attachment of solar panels to the supporting structure, may add considerable cost to a solar panel installation, which in turn may make the cost of electricity or heat generated by that installation more expensive and less cost competitive with similar resources generated by conventional means.

### SUMMARY

A solar panel system, including a target attachment surface, comprising a first and a second solar panel, the first and said second solar panels each including a planar central portion for housing componentry for receiving solar energy, a first side arranged at its proximate end and angled to the planar central portion, a flange extending from the first side and positioned at a distal end of the first side, the flange having holes therein for fastening of said first and second solar panels to said target attachment surface, and a second side arranged at its proximate end and angled to the planar central portion, the second side spaced from the first side, the second side having a distal end for resting on an adjacent solar panel system flange. The first side and flange and second side of the first panel and flange of said second panel cooperate such that the planar central portion of the first solar panel will be planar with the planar central portions of the second solar panel when deployed on the target attachment surface.

In method form, the present disclosure relates to a method for attaching adjacent solar panels on a target attachment surface, comprising providing a first and a second solar panel, the first and said second solar panels each including a planar central portion for housing componentry for receiving solar energy, a first side arranged at its proximate end and angled to the planar central portion, a flange extending from the first side and positioned at a distal end of the first side, the flange having holes therein for fastening of said first and second solar panels to said target attachment surface, and a second side arranged at its proximate end and angled to the planar central portion, the second side spaced from the first side, the second side having a distal end for resting on an adjacent solar panel system flange. This may then be followed by placing the first solar panel on the target attachment surface and placing the second solar panel adjacent the first solar panel such that the flange of the second solar panel contacts the target attachment surface and the second side of the second solar panel rests on the flange of the first solar panel and attaching the first solar panel to the target attachment surface.

### BRIEF DESCRIPTION OF THE DRAWINGS

The features, operation and advantages of the invention may be better understood from the following detailed description of the preferred embodiments taken in conjunction with the attached drawings, in which

FIG. 1 is an orthogonal view of an assembly of two solar panels having an integral mount for attaching to a supporting structure such as a roof, configured in accordance with an embodiment of the present invention; and

FIG. 2 is an elevation view of the sides of two interconnected solar panels as might be assembled and attached to a roof or other supporting structure, in accordance with an embodiment of the present invention.

### DETAILED DESCRIPTION

Still other objects and advantages of the present invention will become readily apparent to those skilled in the art from the following detailed description, wherein it is shown and described preferred embodiments of the invention. As will be realized the invention is capable of other and different embodiments, and its several details are capable of modification in various respects, without departing from the invention. Accordingly, the description is to be regarded as illustrative in nature and not as restrictive.

Techniques are disclosed herein for reducing or eliminating the need for an intermediate supporting rack, which in turn lowers the cost of a solar panel installation. Solar devices may include, for instance, photovoltaic devices that produce electricity from the sun, as well as devices for harvesting thermal energy from the sun. For the purpose of this disclosure, such devices, whether for electrical or thermal applications, are generally referred to herein as solar devices or panels.

In accordance with one exemplary embodiment of the present disclosure, a mount is integrated into the solar panel structure itself by leveraging and complementing existing components or features of a given solar panel structure, thereby eliminating the need for a separate intermediate supporting structure. The mount design may allow for direct attachment of a solar panel to a roof (or other target attachment surface), which may be mechanically sound and weather-tight. In addition, the mount design may ensure that the solar panel has the ability to thermally expand and contract without adversely affecting the weather-tightness or mechanical integrity between adjacent solar panels. Moreover, the mount design may allow the angle of incidence for solar energy to remain unchanged due to thermal expansion. The mount design may leverage components of a solar panel structure to enable a secure attachment to a roof while also enabling relatively fast and relatively inexpensive installation of single or multiple solar panels. Beneficially, the mount design may be achieved with a minimum of materials and labor, relative to conventional mounts.

In one specific embodiment, the mount design may comprise a mounting flange attached to or integrally formed with a first side of a solar panel frame together with a second side of the solar panel frame that is designed to slidingly engage with the mounting flange and first side of an adjacent solar panel. The mount may further include a roof attachment mechanism (e.g., screws, bolts, etc) and weather-tight sealing features incorporated in the mounting flange.

The geometry of the first and second sides of the solar panel frame may be such that they may interlock on installation such that only the first side (via the mounting flange) may need to be secured to a roof or other target surface. This interlocking of the sides to attach one panel to an adjacent panel may effectively allow the mounting flange of the first side to mechanically secure side two of the frame of an adjacent panel. The interlocking may further include pins or similar components protruding from the second side of one solar panel to fit into corresponding holes in the first side of an adjacent panel. Such a pin-based interlocking configuration may accommodate differential thermal expansion between adjacent modules as the bottom of the second side of one panel may be free to slide on the top surface of the mounting flange of the first side of an adjacent panel.

The combination of features of the solar panel frame first and second sides further serves to protect the roof of the building (or other target attachment surface) from water and weather ingress. This may be accomplished by a series of water barriers provided by the way the panels interconnect and may be secured to a roof. Specifically, the second side of the frame may overlap the mounting flange on the first side of the frame of an adjacent panel such that fasteners securing the mounting flange of the adjacent panel may be covered and protected from weather by the panel itself.

The roof may be further protected from water ingress by gaskets on fasteners securing the panel's mounting flanges to a roof deck. The roof may be further protected by a lip, transparent or otherwise, on the top surface of one panel that overlaps an adjacent panel to inhibit ingress of water and snow in the space between adjacent panels. The roof may be yet further protected from water by the use of a flexible sealant or sealants on the bottom of the mounting flange of a panel that conforms to the contours of the roof below it. In some embodiments, the roof at the ends of an array of multiple panels assembled together may be protected by the use of solar panel frame sides without the panels themselves, thereby incorporating the beneficial weather protection features of both sides of panel frames in these assembly terminations. Further, although a roof (e.g., home or building) is referenced herein, embodiments of the present invention may be used with any suitable target mounting surface, such as any platform having exposure to the sun.

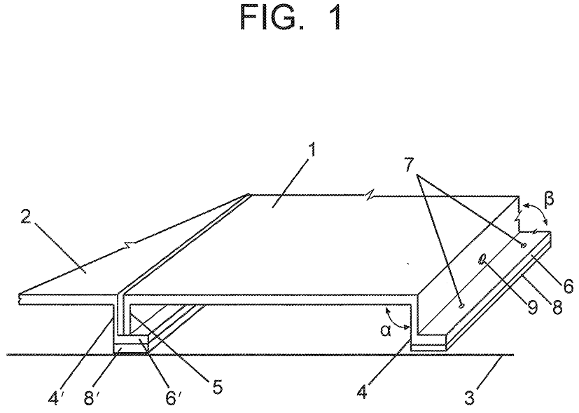

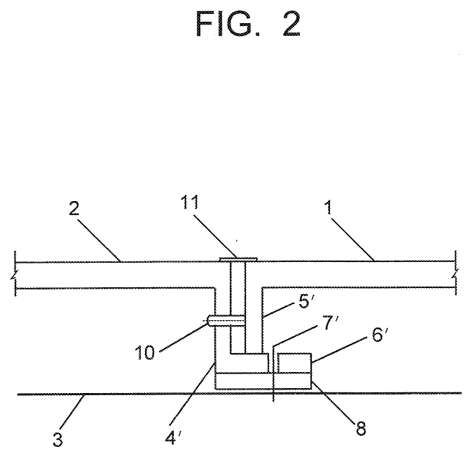

Referring to the drawings, FIG. 1 and FIG. 2 illustrate a mount integrated into a solar panel, in accordance with an embodiment of the present disclosure. As will be apparent in light of this disclosure, the mount may allow for direct attachment of the solar panel to a supporting structure such as a roof, while providing mechanical and weather-resistant integrity. The solar panels with which the mount may be integrated or otherwise used may be of a variety of configurations known in the art, such as photovoltaic modules from silicon or thin films, or solar thermal modules designed to produce hot air or hot water.

Referring to FIG. 1, solar panel 1 is shown as it might be assembled onto a supporting structure such as a roof 3 and joined to an adjacent solar panel 2. Each of the solar panels 1 and 2 may be constructed with frames having different sides as shown. In particular, frame side 4 (4′ for panel 2) comprises a supporting side member that is angled to the planar central portion. This angle alpha (α) may be from 45 degrees to 135 degrees, but preferably, 90 degrees to 100 degrees, in 1 degree increments. Particular preferred is a value of alpha of 90 degrees, +/−5 degrees, or +/−4 degrees, or +/−3 degrees, or +/−2 degrees, or +/−1 degree. The supporting side may then include a mounting flange 6 (6′) positioned at a distal end of the supporting side which mounting flange 6 (6′) may be angled to the side 4 (4′) at an angle beta (β) which may have a value of 45 degrees to 135 degrees, preferably 90 degrees to 100 degrees, in 1 degree increments. Particularly preferred is a value of beta of 90 degrees, +/−5 degrees, or +/−4 degrees, or +/−3 degrees, or +/−2 degrees, or +/−1 degree. See FIG. 1.

Mounting flange 6 (6′) may have holes 7 for fasteners to secure the solar panel to roofing materials (such as roof sheathing) of roof 3. The fasteners may be of various types, such as screws made out of stainless steel for corrosion protection. In general, any suitable fastener may be used, whether mechanical, chemical, or a combination thereof. In addition, a flange gasket 8 may be provided to cover and seal the holes 7 in the mounting flange 6 in order to further enhance the water-tight integrity of the installation.

With further reference to FIGS. 1 and 2, frame side 5 may be constructed to be shorter in height than frame side 4 (4′) and assembled with respect to the adjacent solar panel 2 so that the bottom of frame side 5 of panel 1 rests on top of the mounting flange 6′ of panel 2. Frame side 5 may rest on and be supported by the mounting flange 6′ of frame side 4′ and may be free to slide on mounting flange 6′ to accommodate thermal expansion in the lateral direction. With flangeless frame side 5 shorter than frame side 4′ (with flange 6′), the adjacent solar panel 2 can be assembled to be at the same level as panel 1, to provide uniformity in a series of adjacent panels. In one particular embodiment of the present invention, and as best shown in FIG. 2, the frame side 5 of panel 1 may be installed such that frame side 5 of panel 1 may be outboard of the mounting holes (not shown) in mounting flange 6′ of the adjacent solar panel 2. As such, the mounting hole and its associated fastener may be effectively protected from weather and water ingress. The bottom side of frame side 5 that contacts the top surface of flange 6′ may be configured with a gasket 8′ such as silicon or other suitable material to further improve protection of holes and the associated fasteners.

As can be further seen with reference to FIG. 2, the weather-tight integrity may be further enhanced by the inclusion of a thin cover 11 extending from solar panel 1 to adjacent solar panel 2, or vice-versa. The cover 11 may be configured to provide a leak-free or otherwise positive seal to provide an even greater barrier to water ingress. However, cover 11 need not be a leak-free seal to keep out bulk water, ice or snow. In some embodiments, the cover 11 may comprise, for example, transparent material, such as plastic or glass or durable clear one-sided sticky tape, in order to further allow sunlight to reach the solar panels. In one specific such case, the cover 11 may be less than 3 mm thick to avoid shading of the adjacent panel.

The solar panel frame sides 4 and 5, as well as flange 6, may be constructed of a variety of different materials, including metals, such as aluminum or plastics, such as acrylic or polycarbonate. The frame side 4 and flange 6 may be formed as a single piece, or may be two discrete pieces. In one exemplary embodiment, the solar panel frame sides 4 and 5 and flange 6 may be made of the same materials as the solar panel central portion (generally, the planar area between sides 4 and 5), which may house other components not shown (such as concentrators, absorbers, conductors, electronic circuitry, and other components typical of a solar panel). In one such case, the entire assembly of solar panel frame sides 4 and 5, flange 6, and the central portion of the solar panel may be formed as a unitary structure (frame) using injection molding. In another embodiment, the solar panel frame sides 4 and 5 and flange 6 may be formed separately and then coupled to the central portion of the panel (via mechanical or chemical bonding, or both). In another embodiment, frame side 4 and flange 6 may be formed as a single unitary piece, and that unitary piece, along with a discretely formed frame side 5, may be coupled to the central portion of the panel. The central portion of the panel may similarly be a single unitary piece, or a number of discrete pieces coupled together (via mechanical or chemical bonding, or both). Any number of physical structures will be apparent in light of this disclosure.

“Unitary” structure as used herein refers to a structure that is formed in a single process, such as in forming a side or a flange or the entire frame of the solar panel. As noted above, with plastic structures such process may include, for instance, injection molding or thermoforming or compression molding.

Referring to both FIG. 1 and FIG. 2, and in accordance with embodiments of the present disclosure, a sealant 8 such as closed cell foam may be applied to the bottom of mounting flange 6. In doing so, the sealant 8 may conform to irregularities in the surface of a roof or other mounting surface and help ensure the water-tight integrity of the installation. This integrity may be further enhanced by the inclusion of additional sealants at the point where fasteners installed through holes 7 of mounting flange 6 penetrate the sealant 8 in securing the solar panels in place. For instance, such additional sealant may be layers of roofing membrane sealant (e.g., Grace Ice & Water Shield®), or other suitable liquid or solid sealants used in the roofing industry. During the installation process, the fasteners may coat themselves with these roofing sealants as the fasteners pass through the sealant 8 and further help seal the fastener as it passes through the various roofing layers.

With further reference to FIG. 1 and FIG. 2, adjacent solar panels 1 and 2 may be secured in place by a combination of fasteners, including those fasteners used in holes 7 of mounting flange 6, as well as pins 10 or similar protuberances attached to frame side 5 (of panel 1) that are inserted in corresponding holes 9 in frame side 4′ (of panel 2). In another embodiment, the pins 10 can be attached to frame side 4′ with corresponding holes in frame side 5. Any number of hole/pin configurations are contemplated in light of this disclosure. Such a hole/pin interconnection allows for a relatively fast and relatively inexpensive installation as one solar panel may be inter-joined with another panel already secured to the roof 3, and its flange 6 can be secured to the roof 3 with appropriate fasteners. The procedure can be repeated as necessary for the entire solar panel array.

Various dimensions and tolerances may be used in implementing embodiments of the present disclosure. In one exemplary embodiment, the height from the top of the planar portion of panel 1 to the bottom surface (that touches the roof 3) of mounting flange 6 is about 2 to 4 inches. The height from the top of the planar portion of panel 1 to the bottom surface of side 5 (that touches top of adjacent flange 6′) is about 2 to 4 inches, less the thickness of the flange 6′. The thickness of flange 6 (6′) may be, for example, from about ⅛ to ¾ inches. The central portion of the panel may be, for example, about 2 to 4 feet square, or rectangular, about 2 to 4 feet long and 1 to 3 feet wide. The depth of the panel will depend on factors such as the componentry therein (such as concentrators and absorbers). As will be appreciated, the dimensions of sides 4 and 5 and flange 6 may generally depend on the size and shape of the central portion of the panel, and the weight of the overall assembly. The present disclosure is not intended to be limited to any particular set of dimensions or geometries.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be not be limited by this detailed description, but rather by the claims appended hereto.

What is claimed is:

1. A solar panel system, including a target attachment surface, comprising:
a first and a second solar panel, said first and said second solar panels each including;
a planar central portion for housing componentry for receiving solar energy;
a first side arranged at its proximate end and angled to the planar central portion;
a flange extending from said first side and positioned at a distal end of the first side, the flange having holes therein for fastening of said first and second solar panels to said target attachment surface; and
a second side arranged at its proximate end and angled to the planar central portion, the second side spaced from the first side, the second side having a distal end for resting on an adjacent solar panel system flange;
wherein the first side and flange and second side of said first panel and flange of said second panel cooperate such that the planar central portion of the first solar panel will be planar with the planar central portions of the second solar panel when deployed on the target attachment surface.

2. The system of claim 1 wherein the first side and the flange are formed as a unitary structure.

3. The system of claim 1 wherein the first side, second side, flange, and planar central portion are formed as a unitary structure.

4. The system of claim 1 wherein said componentry for receiving solar energy includes at least one of concentrators and absorbers.

5. The system of claim 1 wherein the first side of each of said panels further includes a hole therethrough and the second side of each of said panels further includes a pin, such that when deployed as adjacent solar panels, the hole of the first side receives the pin of the second side of an adjacent solar panel.

6. The system of claim 1 wherein the second side of each of said panels further includes a hole therethrough and the first side of each of said panels further includes a pin, such that when deployed as adjacent solar panels, the hole of said second side receives the pin of the second side of an adjacent solar panel.

7. The system of claim 1 wherein when deployed as adjacent solar panels, the system further includes a transparent cover that extends from the planar central portion of said first solar panel proximate the first side to the planar central portion of said second solar panel proximate the second side, wherein the transparent cover is 5 millimeters or less in thickness.

8. The system of claim 1 further including a sealant, wherein the flange further includes a bottom surface and said sealant resides between said bottom surface and the target attachment surface.

9. A method for attaching adjacent solar panels on a target attachment surface, comprising:
providing a first and a second solar panel, said first and said second solar panels each including a planar central portion for housing componentry for receiving solar energy, a first side arranged at its proximate end and angled to the planar central portion, a flange extending from said first side and positioned at a distal end of the first side, the flange having holes therein for fastening of said first and second solar panels to said target attachment surface, and a second side arranged at its proximate end and angled to the planar central portion, the second side spaced from the first side, the second side having a distal end for resting on an adjacent solar panel system flange;
placing said first solar panel on said target attachment surface;
placing said second solar panel adjacent said first solar panel such that said flange of said second solar panel contacts said target attachment surface and said second side of said second solar panel rests on said flange of said first solar panel; and
attaching said first solar panel to said target attachment surface.

10. The method of claim 9 wherein the first side and flange and second side of said first panel and flange of said second panel cooperate such that the planar central portion of the first solar panel will be planar with the planar central portions of the second solar panel when deployed on the target attachment surface.

11. The method of claim 9 wherein said flanges include a hole for mounting said panels to said attachment surface and said method further includes providing a fastener and fastening said solar panels to said attachment surface by installing said fastener through said hole.

12. The method of claim 9 wherein the flange further includes a bottom surface and a sealant is provided between said bottom surface and the target attachment surface.
